(19) United States
(12) Patent Application Publication
(10) Pub. No.: US 2007/0094295 A1
(43) Pub. Date: Apr. 26, 2007

(54) System and method for hierarchical display in a procurement transaction

(76) Inventors: Benjamin Klehr, Rastatt (DE); Tanja Sohngen, Altlussheim (DE); Paola Sala, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/255,960

(22) Filed: Oct. 24, 2005

(51) Int. Cl. G06F 7/00

(52) U.S. Cl. 707/102

(57) ABSTRACT

Systems and methods are disclosed for providing a hierarchical display of business partners associated with a procurement-related document in a computer system. The procurement-related document may be an invoice, a purchase order, a bidding, a good receipt, a contract, or any other suitable document within the context of the particular system. A plurality of business partners associated with the procurement-related document and/or the interface may be identified. Identification of the business partners may additionally include identification of relationships between the business partners. The identified business partners may be displayed to the user. The display may show various attributes associated with the business partners and may show the business partners in a hierarchical arrangement to indicate their relationships with each other.

### FIELD OF THE INVENTION

The present invention relates generally to interfaces in a computer system. More specifically, the present invention relates to the hierarchical display of business partners associated with a procurement-related document in an interface of a computer system.

### BACKGROUND OF THE INVENTION

Business transactions are essentially exchanges between different business partners. Generally, a business partner may be an individual, a group of individuals, a company, or any other entity that is recognizable by other such entities as being capable of participating in exchanges. Consistent with this definition, business transactional software and systems are instruments for facilitating the exchanges between different business partners. It is, thus, critical for these software and systems to be able to accurately identify the business partners involved in the exchanges. It is also often desirable for these software and systems to be able to make the user aware of the business partners, including their respective roles and their relationships with each other, so that the user may verify the data, for example, to ensure that proper actions are directed towards appropriate partners.

User identification of business partners, particularly their roles and/or relationships with each other, are especially important in a procurement-related system, which is generally directed to the trading of goods between partners. A procurement-related system may include functionalities such as issuing purchasing orders, creating invoices, documenting goods receipt, and any other suitable procurement-related functionalities. Such a system typically provides for user interaction in user interfaces, and identification of at least one business partner is generally required in every user interface.

As an example, a user, when inputting a purchase order, generally makes reference to one or more vendors, one or more purchasers, and/or other business partners. As another example, when documenting a received invoice, it is important to identify which vendor the product came from, the sales agent that had carried out the sale, any invoicing party that is to be paid, and any other business partners involved in the invoiced transactions.

While known procurement-related systems are capable of identifying the business partners internally for the purpose of processing transactions involving these partners, they fail to provide a comprehensive way for the user to view the business partners, especially any relationships between the various business partners. Thus, it is desirable to provide a method and system that enables the user to view, in a computer system, a display of business partners associated with a procurement-related document, in which the partners' respective roles and relationships with other partners are clearly indicated, for example, in a hierarchical arrangement.

### SUMMARY OF THE INVENTION

Consistent with the principles of the present invention, systems and methods are disclosed for providing a hierarchical display of business partners in a computer system.

Consistent with the principles of the present invention, the display of business partners may be associated with a procurement-related document. The procurement-related document may be an invoice, a purchase order, a bidding, a good receipt, a contract, or any other suitable document within the context of the particular system. It will be understood that the procurement-related document may be system specific and may differ substantially from any standard or customary document, such as, for example, a standard invoice or purchase order, without exceeding the scope of the present invention.

An interface may be provided in connection with the procurement-related document. The interface may display various information associated with the procurement-related document and may enable the user to input, modify, or otherwise interact with the information. A plurality of business partners associated with the procurement-related document and/or the interface may be identified. The scope of the plurality of business partners identified may vary consistent with the principles of the present invention.

Consistent with the principles of the present invention, identification of the business partners may additionally include identification of relationships between the business partners. The relationships between the business partners may be pre-defined. Moreover, the plurality of business partners identified may be displayed to the user. The display may be automatically triggered or may be shown, for example, in response to a user request, such as a request to display a business partner overview, in response to the user performing an action, such as a partner-related action, or in response to any other suitable triggering events. The display of the business partners may show various attributes associated with the business partners, which may include business partner functions, roles, names, reference numbers, actions that may be taken in association with the business partner, and any other suitable attributes. Any relationship between the business partners may also be reflected in the display of the business partners.

Consistent with the principles of the present invention, business partners may be shown in a hierarchical arrangement to indicate their relationships with each other. As an example, a contact person may be displayed immediately below the vendor for whom the contact person works for. The contact person may be indicated as being in a hierarchical relationship with the vendor by, for example, being displayed with an indentation below the vendor and may additionally be associated with a sub-level indicator.

Consistent with the principles of the present invention, more than one of the above relationships may be displayed simultaneously. All or some of these relationships may be displayed hierarchically as described above. Consistent with the principles of the present invention, a hierarchical display having many sublevels may be included. Consistent with the principles, one business partner may have multiple associated business partners that are displayed at a sublevel in a hierarchical arrangement. Any other suitable hierarchical displays of business partners may be shown without departing from the spirit of the present invention.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary invoice entry screen in which a partner overview is displayed consistent with the principles of the present invention.

FIG. 2 is an exemplary purchase order entry screen in which a partner overview is displayed consistent with the principles of the present invention.

FIG. 3 is a flow chart of illustrative steps involved in providing a hierarchical display of business partners associated with a procurement-related document in a computer system consistent with the principles of the present invention.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

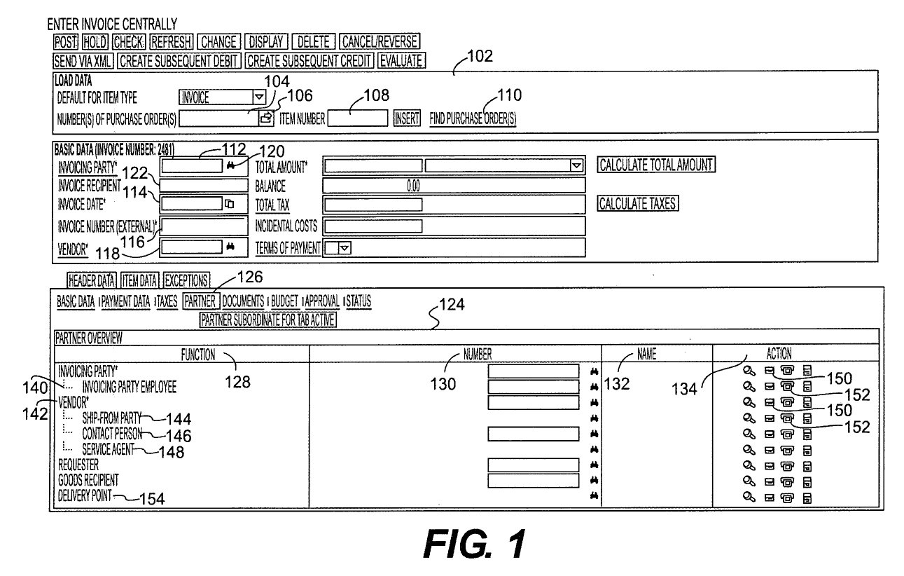

FIG. 1 is an exemplary invoice entry screen 100 in which a partner overview is displayed consistent with the principles of the present invention. The invoice input entry screen 100 may be provided to allow a user to enter a new invoice, for example in response to receiving an invoice or in response to any other appropriate event.

A load data section 102 may be provided on screen 100. In this section, the user may insert items into the invoice, for example, by loading data associated with the items from one or more related documents in the system. In this particular example, the user is allowed to load item data from a number of existing purchase orders. For example, the user may provide a known purchase order number of a related purchase order in field 104. The user may obtain this number, for example, from a received invoice, which references the purchase order.

In accordance with a system consistent with the principles of the present invention, the user may press button 106 to display a new screen or interface in which the user may enter or select multiple purchase orders, for example, using a mechanism for multiple selection. In the event that the user does not know the specific purchase order number of one or more related purchase order, the user may request a general search for the one or more purchase order using, for example, the find purchase order option 110. In this option, the user may use various criteria, such as a vendor, an invoicing party, or any other suitable criteria, to search for a related purchase order. While data loading from related documents such as a purchase order is specifically described above, it is not the only way to input item data into an invoice. The user may manually input various invoice and item data or use any other suitable input means for entering such data without departing from the spirit of the present invention.

In addition to loading invoice data from preexisting documents, the user may also manually enter data into various fields of the invoice entry. For example, the user may input data for invoicing party 112, invoice date 114, external invoice number 116, vendor 118, and a number of other suitable types of information. When entering invoicing party in field 112, the user may invoke a search function using, for example, search icon 120. In response to the user invoking the search option, the system may search, for example, a list, a database, or other such means associated with the immediate document or interface, a master list, a database, or other such means of invoicing parties stored on the system, a list of invoicing parties associated with the current user, a list or database associated with any related documents such as a purchase order, or any other suitable list or database. A similar search may be performed for the entry of vendor 118.

When inputting invoicing data in screen 100, certain types of information may be prevented from user modification, for example, to prevent human errors or unauthorized data manipulation. Prevention of user modification may be achieved by, for example, making the data field inactive or by using any other suitable method. In the present example, the field invoice recipient 122 is made inactive. This may prevent a user, who may be the invoice recipient, from making modification to this field. An inactive field or other such restricted information may be made available for modification, for example, when the user is identified as an authorized user for making such modifications.

Consistent with the principles of the present invention, a partner overview 124 may be displayed in screen 100. Partner overview 124 may be displayed, for example, in response to the user selecting partner tab 126. In some system consistent with the principles of the present invention, all partners who are associated with the content of the present screen or interface may be displayed in partner overview 124. In some systems consistent with the principles of the present invention, partner overview 124 may also include business partners that are not immediately present on the current screen or interface, but are related to the content of the current screen or interface, for example, as a part of a procurement-related document that may be represented by a number of related screens or interfaces. The scope of business partners displayed in partner overview 124 of the present example is merely illustrative. It will be understood that any suitable arrangement for defining the scope of the business partners to be displayed may be within the spirit of the present invention. The definition of the scope may be performed by the system automatically, by a user of the interface, by an authorized master user, or by any other suitable means.

In partner overview 124, business partners may appear in a list. In the present example, business partners are listed in a table, each occupying a row. Columns of the table may specify the partner's function or role 128, indicate any reference number 130 for the business partner, the name 132 of the business partner, any action options 134 that may be taken in connection with the business partner, and/or any other suitable attribute associated with the business partner. It will be understood that columns 128-134 are merely illustrative of the types of attributes that may be included for a business partner and any suitable attributes may be used without departing from the spirit of the present invention.

Consistent with the principles of the present invention, relationships between the business partners may be illustrated in partner overview 124. The relationships between the business partners may be shown by displaying the business partners in a hierarchical arrangement, for example, based on their respective roles 128. In the example of partner overview 124, business partner invoicing party 136 may be a company, a department of a company, or any other suitable entity. Invoicing party 136 may have an employee 138, who is also a business partner. Invoicing party employee 138 may be an individual employed by invoicing party 136 and given specific business partner tasks within the context of an invoicing party, for example, to issue invoices, to resolve refunds, to serve as a general contact person for the invoicing party, and/or to perform any other suitable task of a business partner.

Because invoicing party employee 138, in this example, is clearly related to invoicing party 136 and may have a more specific set of responsibilities or more limited level of authority, it would be advantageous to display invoicing party employee 138, for example, as a sub-entity or sub-level business partner to invoicing party 136 in a hierarchical layout. In this particular example, the sub-level status of invoicing party employee 138 is indicated by indenting the display of invoicing party employee 138 below the display of invoicing party 136 and providing a sub-level indicator 140 to indicate the hierarchical relationship between the business partners. Also in the current example, a business partner such as vendor 142 may have a hierarchically represented relationship with more than one business partner. Each of ship-from party 144, contact person 146, service agent 148 may be displayed as a sub-entity to vendor 142, as indicated by being displayed with an indentation and an associated sub-level indicator 140.

Additionally, it is within the scope of the present invention to include more than one level of hierarchical relationship in partner overview 124. For example, each of invoicing party employee 138, ship-from party 144, contact person 146, and service agent 148 may have additional hierarchically represented relationships with one or more other business partners, where invoicing party employee 138, ship-from party 144, contact person 146, and service agent 148 are at a superior level in the hierarchically represented relationship.

As mentioned above, each of the business partners, regardless of its position in the hierarchical layout may be associated with a set of attributes, including a set of actions 134 that the user may performed in connection with the business partner. As an example, the user may send mail to a business partner by invoking a mailing function using, for example, mail icon 150. In some system consistent with the principles of the present invention, the actions that may be performed in connection with the business partners may vary from partner to partner. As an example, the set of actions that may be performed may depend on the role of the business partner. More specifically, vendor 142, who has a designated contact person 146 and service agent 148 to address, for example, customer questions and service requests, may not want to be directly contacted by the user. In such a case, the actions that the user may take with respect to vendor 142 may be restricted, for example, by removing mail and phone options from its set of associated actions. Mail icon 150 and phone icon 152, which are displayed in connection with vendor 142 may be removed or made inactive when such user actions are restricted.

In some systems consistent with the principles of the present invention, the scope of business partners may be expanded to include important elements or functions of a business transaction that are not immediately recognizable as a business partner. For example, in partner overview 124, a delivery point 154 is listed in the same table with business partners. While delivery point 154 doesn't reference a particular individual or company, it may be associated with an individual or groups of individuals to which actions from the user may be directed. As an example, it may be very useful for the user to be able to contact personnel at delivery point 154, for example, to obtain status of goods that are being delivered. Therefore, partner overview 124 may include these types of business partners in order to allow the user to make easy identification of these useful elements and functions of a business transaction and to take actions in connection with them.

It will be understood that the layout of partner overview 124 is merely illustrative of such a display screen or interface. Any other suitable display screen or interface in which business partners may be displayed in a hierarchical fashion may be used without exceeding the scope of the present invention.

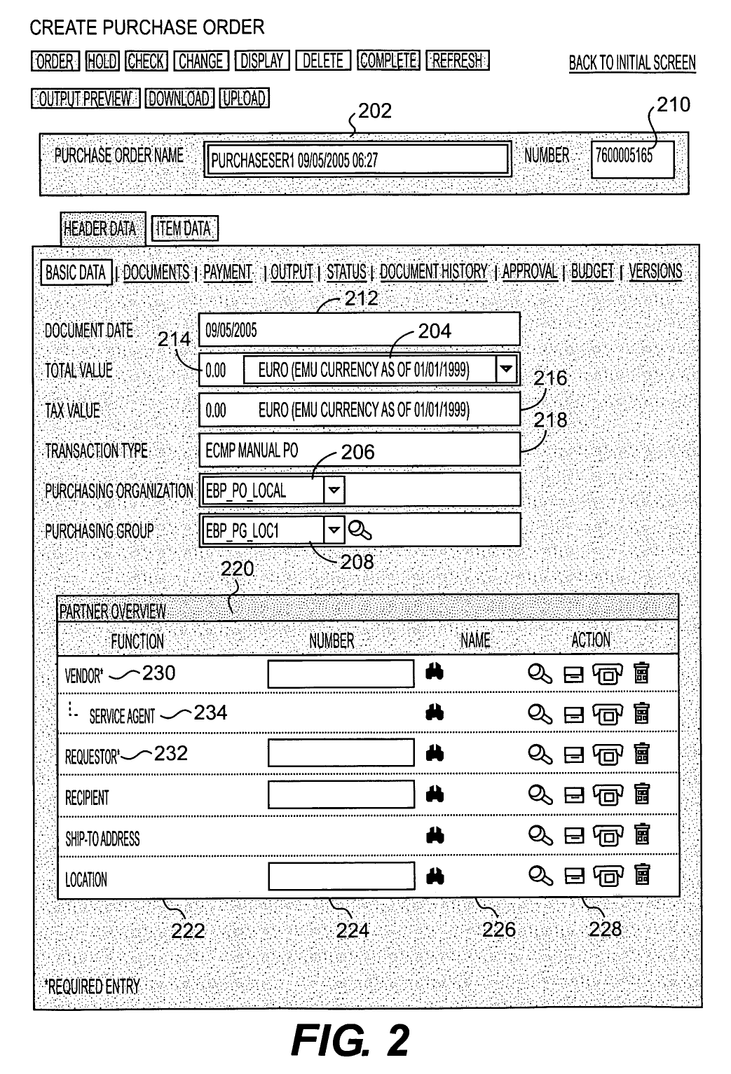

As mentioned above, business transactions are essentially about exchanges between different partners. Therefore, identification of business partners, their roles and their relationships with each other are useful if not critical in many situations. One useful situation for displaying a partner overview to the user was discussed above in connection with FIG. 1. FIG. 2 provides another screen or interface 200 in a procurement-related system in which business partners may be displayed. Similar to the invoice entry screen or interface of FIG. 1, purchase order entry screen or interface 200 of FIG. 2 may include both active and inactive input fields. For example, the user may input a purchase order name 202, select the appropriate currency 204 for the total value, select the appropriate purchasing organization and purchase group from drop down menus 206 and 208. Information such as system-assigned purchase order number 210, document date 212, and any other suitable system-assigned information may be made inactive or otherwise non-modifiable. Other non-modifiable information may include total value 214, which may be automatically calculated, for example, based on items involved in the purchase order, thereby minimizing human errors in calculation. Tax value 216 may also be automatically calculated based on, for example, a pre-defined formula using the total value 214 as input. Transaction type 218 may be determined based on the type of purchase order entry, which the user may have selected prior to the display of the current purchase order entry screen 200. It will be understood the determination of which information to include, to make modifiable or non-modifiable in purchase order screen or interface 200 may be varied from the above example without departing from the spirit of the present invention.

A partner overview 220 may be included in screen 200. Partner overview 220 may be very similar to partner overview 124 of FIG. 1, and may display various business partners who are associated with, for example, the immediate interface, a procurement-related document associated with the immediate interface, a business transaction in connection with the immediate interface, a number of related business transactions in connection with the immediate interface, or any other suitable set of business partners. As described previously in connection with partner overview 124 of FIG. 1, various attributes associated with a partner may be included in partner overview 220, which may include partner function 222, partner number 224, partner name 226, various actions 228 that may be taken with respect to the partner, or any other suitable attributes.

Depending on the interface and the business transaction or procurement document that the interface is directed to, some partner functions 222 may be required to be associated with such transactions and documents. In these cases, the required business partners, such as vendor 230 and requestor 232 may be indicated as being required, for example, with an asterisk, in partner overview 220. In the present example, vendor 230 is associated with a service agent 234, who may perform some of the functions that are generally carried out by vendor 230. The server agent is, thus, a sub-entity of vendor 230 and may be displayed hierarchically in relation to vendor 230 to indicate its sub-level status and relationship with vendor 230.

From the above examples, it is easy to see the benefits of including a partner overview or other suitable display of business partners in an interface or screen in which information regarding a procurement-related document or information regarding any business transaction involving exchanges between business partners are being displayed. It will also be understood that a hierarchical relationship may exist among business partners of varying types and at various levels.

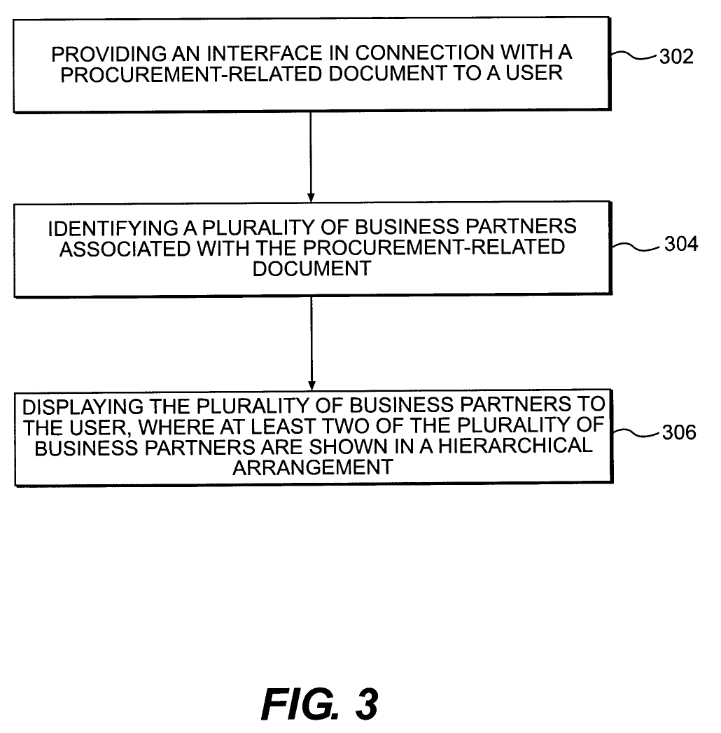

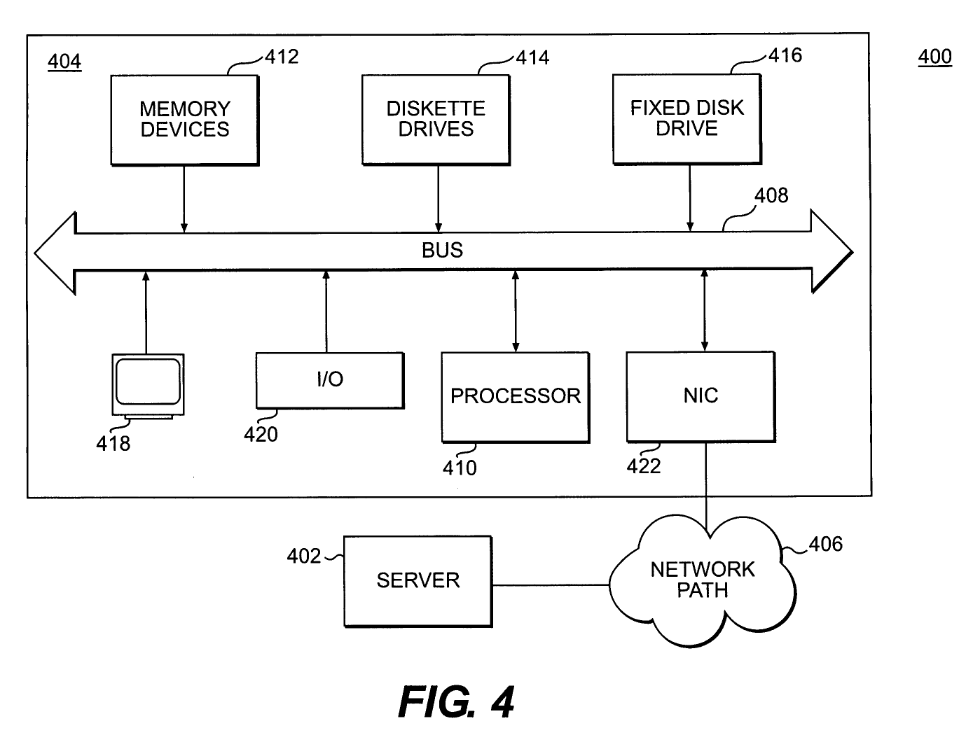

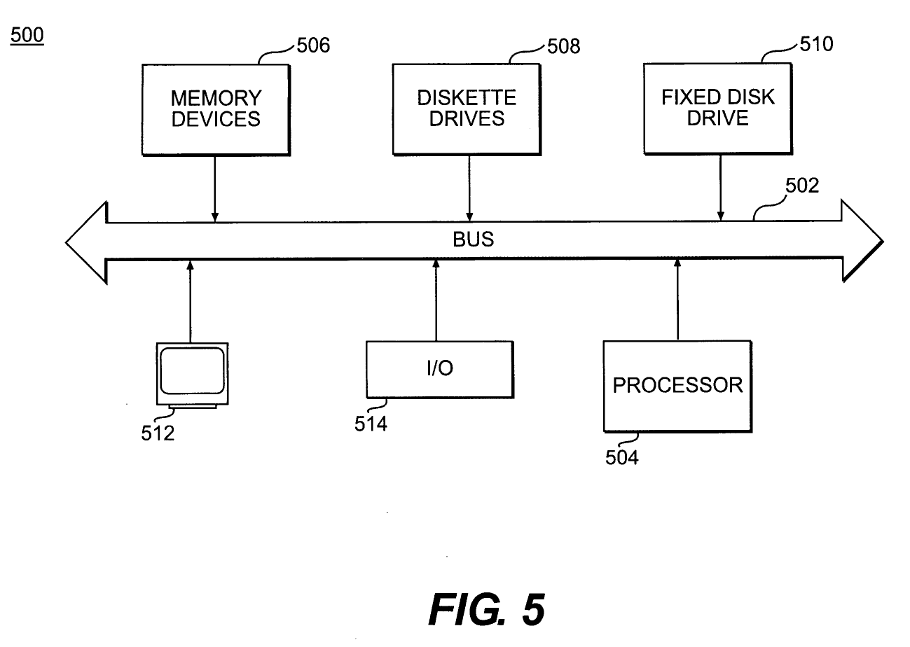

FIG. 3 is a flow chart of illustrative steps involved in presenting a hierarchical display of business partners associated with a procurement-related document in an interface of a computer system consistent with the principles of the present invention. The procurement-related document may be an invoice, a purchase order, a bidding, a good receipt, a contract, or any other suitable document. The computer system may provide for user interactions with the procurement-related document in one or more user interfaces or screens.

At step 302, the system may provide the user with an interface in connection with a procurement-related document. As an example, the interface may be associated with an invoice document, a purchase order document, or any other suitable procurement-related document. It will be understood that the procurement-related document referred to may be any document within the context of the particular system. Thus, the procurement-related document may differ in various ways or substantially from any standard or customary document, such as, for example, a standard invoice or purchase order, without exceeding the scope of the present invention. The interface of step 302 may display various information associated with the procurement-related document and may enable the user to input, modify, or otherwise interact with the information in the interface.

At step 304, a plurality of business partners associated with the procurement-related document may be identified. The scope of the plurality of business partners that are identified may vary consistent with the principles of the present invention. For example, in some systems consistent with the principles of the present invention, only business partners that are associated with the immediate interface may be identified. In some systems consistent with the principles of the present invention, all business partners associated with any transactions or documents that are referenced by the immediate interface or by the document in connection with the immediate interface, may be identified. It will be understood that the scope of the business partners identified at step 304 may vary based on system definition, user definition, or any other suitable definition, without departing from the spirit of the present invention.

The identification of the business partners may be automatically performed by the system, may be performed in response to a user requesting such identification, or may be performed based on any other triggering event. As an example, the user may request identification of business partners by requesting, in an interface, displaying of a business partner overview such as the partner overviews of FIGS. 1 and 2. Alternatively, business partners may be automatically identified, for example, as soon as an interface in connection with a procurement-related document is displayed or at any other suitable system-determined time.

In some systems consistent with the principles of the present invention, identification of the business partners at step 304 may additionally include identification of relationships that link the business partners together. The relationships between the business partners may be pre-defined. As an example, an authorized user may define the business partners and any relationships that the business partner may have with other business partners. For example, an authorized user may define a vendor and a contact person, where the contact person is always associated with that vendor and is designated by the vendor to handle the vendor's communication needs. If such a relationship exists for a partner associated with, for example, the interface of step 302, the relationship may be identified in connection with the business partner at step 304. Consistent with the principles of the present invention, the identification of relationships may be performed by ABAP coding or any other suitable means.

At step 306, the plurality of business partners may be displayed to the user. The display may be automatically triggered, for example, in response to the user displaying the initial interface at step 302. Alternatively the display may be shown, for example, in response to a user request, such as a request to display a business partner overview, in response to the user performing an action, such as a partner-related action, or in response to any other suitable triggering events.

Consistent with the principles of the present invention, the display of the business partners may be directly incorporated into, for example, the initial interface, such as the interface of step 302. Alternatively, the display may be provided separately in another interface, which may be displayed simultaneously with the initial interface of step 302, displayed entirely separately in another screen, or provided in any other suitable manner. Regardless of how the business partners are displayed to the user, the information gathered during the identification step 304, which may include the various attributes associated with the business partners, relationships between the business partners, and any other suitable information, may be provided, for example, to the interface that is handling the displaying at step 306.

The display of the business partners may take various forms. One example is to list the business partners in a table form, as shown in FIGS. 1 and 2. Various attributes of the business partners may be displayed in columns of the table. The attributes may include business partner functions, roles, names, reference numbers, actions that may be taken in association with the business partner, and any other suitable attributes. Not all of the identified attributes may necessarily be displayed at step 306. Any subset of these attributes may be displayed without departing from the spirit of the present invention.

Any relationship between the business partners may also be reflected in the display of the business partners at step 306. Consistent with the principles of the present invention, business partners may be shown in a hierarchical arrangement to indicate their relationship with each other. As an example, a contact person may be displayed immediately below the vendor for whom the contact person works for. The contact person may be indicated as being in a hierarchical relationship with the vendor by, for example, being displayed with an indentation below the vendor and may additionally be associated with a sub-level indicator. Examples of such displays are shown in FIGS. 1 and 2.

Consistent with the principles of the present invention, more than one such relationships may be displayed simultaneously at step 306. All or some of these relationships may be displayed hierarchically as described above. In some systems consistent with the principles of the present invention, a hierarchical display having many sublevels may be included. In some systems consistent with the principles of the present invention, one business partner may also have multiple associated business partners that are displayed at a sublevel in a hierarchical arrangement. Any other suitable hierarchical displays of business partners may be shown at step 306 without departing from the spirit of the present invention.

A computer system may be used to install a software application implementing a system and method consistent with the principles of the present invention. The computer system may be a computer network, as shown in FIG. 4, or a stand-alone personal computer (PC), as shown in FIG. 5.

As shown in FIG. 4, a computer network 400 consistent with the principles of the present invention may include a server 402 and a stand-alone PC 404 connected through a network path 406. Computer network 400 may be a local area network (LAN), where server 402 and PC 404 are workstations. Computer network 400 may also be the Internet, with server 402 hosting a web application and PC 404 being any workstation available to a user desiring to interface with the application on server 402. Alternatively, computer network 400 may be a wide area network (WAN), and server 402 and PC 404 may lie in two separate LANs connected through the Internet.

PC 404 may include a bus line 408 connecting a plurality of devices such as a processor 410, memory devices 412 for storage of information, diskette drives 414, a fixed disk drive 416, a monitor or display 418, other I/O devices 420, and a network interface card (NIC) 422. Processor 410 may be a microprocessor such as an Intel Pentium™ chip for processing applications. Memory devices 412 may include read-only memories (ROM) and/or random access memories (RAM). Diskette drives 414 may include a floppy drive and/or a compact disk (CD) drive. Fixed disk drive 416 may be a hard drive. I/O devices 420 may include a keyboard and/or a mouse for receiving input from a user of PC 404. Monitor or display 418 may display output from processor 410, and may also echo the input of the user. PC 404 may be connected to network path 406 through NIC 422.

A web application may be installed on server 402. An individual desiring to enter data into the application on server 402 may use a web browser loaded on PC 404, and may communicate with server 402 through NIC 422 and network path 406. In one aspect, software application for implementing a system consistent with the principles of the present invention may be stored in PC 404 and processor 410 of PC 404 may execute the software application locally within PC 404 and interface with a web application on server 402. Particularly, the software application may be stored on a floppy disk, a CD, or any other suitable readable media, which may be accessible by diskette drive 414, fixed disk drive 416, or any other suitable mechanism. In another aspect, the software application for implementing a system consistent with the principles of the present invention may be stored in server 402, which may execute the software application, and processor 410 of PC 404 may communicate with server 402 to send information to server 402 and retrieve the results of the execution of the software application from server 402. Through the execution of the software application implementing a system consistent with the principles of the present invention, either locally within PC 404 or remotely within server 402, an interface may be provided on a user display.

Alternatively, as shown in FIG. 5, a stand-alone PC 500 may be used for implementing a software application implementing a system consistent with the principles of the present invention. PC 500 may include a bus line 502 connecting a plurality of devices, which may include a processor 504, memory devices 506 for storage of information, diskette drives 508, a fixed disk drive 510, a monitor or display 512, and other I/O devices 514. Processor 504 may be a microprocessor such as an Intel Pentium™ chip for processing applications. Memory devices 506 may include ROM and/or RAM. Diskette drives 508 may include a floppy drive and/or a compact disk (CD) drive. Fixed disk drive 510 may be a hard drive. Monitor or display 512 may display the output of processor 504 and may also echo the input of the user. I/O devices 514 may include a keyboard and/or a mouse for receiving input from a user of PC 500.

A software application implementing a system consistent with the principles of the present invention may be stored on a floppy disk or a CD accessible by diskette drive 508 or on fixed disk drive 510. Processor 504 may execute the software application stored in the floppy disk the CD or the fixed disk drive 510. An individual, through monitor or display 512 and I/O devices 514, may interact with processor 504, which may execute the software application. A software application implementing a system consistent with the principles of present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for hierarchically displaying business partners associated with a procurement-related document in a computer system, the method comprising:
providing an interface in connection with the procurement-related document to a user;
identifying a plurality of business partners associated with the procurement-related document; and
displaying the plurality of business partners to the user, wherein at least two of the plurality of business partners are shown in a hierarchical arrangement.

2. The method of claim 1, wherein the procurement-related document is an invoice.

3. The method of claim 1, wherein the procurement-related document is a purchase order.

4. The method of claim 1, wherein identifying the plurality of business partners associated with the procurement-related document comprises identifying a relationship between at least two of the plurality of business partners.

5. The method of claim 4, further comprising displaying the at least two business partners having the relationship in the hierarchical arrangement, wherein one of the at least two business partners is shown as a sub-level business partner to the other of the at least two business partners.

6. The method of claim 1, wherein identifying the plurality of business partners comprises identifying one or more attributes of at least one of the plurality of business partners.

7. The method of claim 6, wherein displaying the plurality of business partners to the user includes displaying at least one of the attributes of at least one of the plurality of business partners.

8. A system for hierarchically displaying business partners associated with a procurement-related document, the system comprising:
a display; and
a processor configured to:
provide an interface on the display in connection with the procurement-related document to a user;
identify a plurality of business partners associated with the procurement-related document; and
display the plurality of business partners to the user on the display, wherein at least two of the plurality of business partners are shown in a hierarchical arrangement.

9. The system of claim 8, wherein the procurement-related document is an invoice.

10. The system of claim 8, wherein the procurement-related document is a purchase order.

11. The system of claim 8, wherein the processor is further configured to identify a relationship between at least two of the plurality of business partners.

12. The system of claim 11, wherein the processor is further configured to display the at least two business partners having the relationship in the hierarchical arrangement on the display, wherein one of the at least two business partners is shown as a sub-level business partner to the other of the at least two business partners.

13. The system of claim 8, wherein the processor is further configured to identify one or more attributes of at least one of the plurality of business partners.

14. The system of claim 13, wherein the processor is further configured to display at least one of the attributes of at least one of the plurality of business partners.

15. A computer-readable medium including instructions for performing, when executed by a processor, a method for hierarchically displaying business partners associated with a procurement-related document in a computer system, the method comprising:
providing an interface in connection with the procurement-related document to a user;
identifying a plurality of business partners associated with the procurement-related document; and
displaying the plurality of business partners to the user, wherein at least two of the plurality of business partners are shown in a hierarchical arrangement.

16. The computer-readable medium of claim 15, wherein the procurement-related document is an invoice.

17. The computer-readable medium of claim 15, wherein the procurement-related document is a purchase order.

18. The computer-readable medium of claim 15 further includes instructions for identifying a relationship between at least two of the plurality of business partners.

19. The computer-readable medium of claim 18 further includes instructions for displaying the at least two business partners having the relationship in the hierarchical arrangement, wherein one of the at least two business partners is shown as a sub-level business partner to the other of the at least two business partners.

20. The computer-readable medium of claim 15 further includes instructions for identifying one or more attributes of at least one of the plurality of business partners.

21. The computer-readable medium of claim 20 further includes instructions for displaying at least one of the attributes of at least one of the plurality of business partners.
